(19) United States
(12) Patent Application Publication
(10) Pub. No.: US 2010/0237813 A1
(43) Pub. Date: Sep. 23, 2010

(54) BRUSHLESS MOTOR DRIVING APPARATUS

(76) Inventors: Kunio Seki, Tokyo (JP); Kazutaka Inoue, Kyoto (JP); Hiroyuki Kikuta, Kyoto (JP); Yuichi Ohkubo, Ganma (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/719,525

(22) Filed: Mar. 8, 2010

(30) Foreign Application Priority Data
Mar. 19, 2009 (JP) 2009-067881

(51) Int. Cl. H02P 6/14

(52) U.S. Cl. 318/400.13

(57) ABSTRACT

A brushless motor driving apparatus that includes a rotation signal output component, a half-cycle signal generating component, a plurality of counters, and a duty control signal generating component is provided. The plurality of counters, each of which uses a different bit number to count, repeatedly resets a count value and restarts a count operation for every bit number, resets a count value together with rising or falling of a half-cycle signal, and outputs a pulse signal which is inverted for every reset that occurs while the count operation is being performed. The duty control signal generating component generates a duty control signal to determine a duty ratio of a control signal to control driving of a single-phase brushless motor, based on at least two pulse signals selected from the pulse signals output from the plurality of counters.

### CROSS-REFERENCE TO RELATED APPLICATIONS

This application is based on and claims priority under 35 U.S′.C. § 119 from Japanese Patent Application No. 2009-067881 filed Mar. 19, 2009, the disclosure of which is incorporated by reference herein.

### RELATED ART

1. Field of the Disclosure

The disclosure relates to a brushless motor driving apparatus and, more particularly, to a brushless motor driving apparatus that can control a duty ratio of a control signal to control driving of a brushless motor to restrict a rotation speed.

2. Description of the Related Art

In general, a duty ratio of a pulse current that flows through a coil is controlled to restrict a rotation speed of a motor and reduce a noise.

For example, a two-phase brushless motor driving apparatus is suggested (refer to Japanese Patent Application Laid-Open (JP-A) No. 2002-315384). The two-phase brushless motor driving apparatus counts a clock signal by a first counter to clock a rotation cycle of a rotor, determines a rising edge of a duty control pulse by an output of a counter performing a count operation with a clock having a high frequency in second and third counters counting count values of the first counter with clocks having different frequencies, determines a falling edge of the duty control pulse by an output of the counter performing a count operation with a clock having a low frequency, and changes a duty.

However, according to the technology that is disclosed in JP-A No. 2002-315384, a clock frequency needs to be changed for every counter, and plural oscillators or one reference frequency oscillation circuit and multiple-stage division circuits need to be provided to manage clock frequencies in an integrated circuit. If the plural different clock frequencies are mixed, beats are generated between the frequencies or a high frequency signal causes crosstalk on a low frequency signal line, thereby causing an erroneous operation due to interference. For this reason, a layout design of an integrated circuit that considers the above circumstance is needed. As such, in order to generate the plural frequencies and prevent the erroneous operation, an area of the integrated circuit increases, and consumption power increases.

### INTRODUCTION TO THE INVENTION

Accordingly, the present disclosure has been made to resolve the above-described problem, and it is an object of the disclosure to provide a brushless motor driving apparatus that can perform duty control to restrict a rotation speed of a motor, without requiring a complicated circuit.

According to an aspect of the disclosure, there is provided a brushless motor driving apparatus that includes: a rotation signal output component that outputs a rotation signal that represents one cycle corresponding to one rotation of a rotation body of a single-phase brushless motor; a half-cycle signal generating component that generates a half-cycle signal in which a rising or falling edge is inverted every half cycle of the rotation body, based on the rotation signal output from the rotation signal output component, and outputs the half-cycle signal; a plurality of counters, each of which uses a different bit number to count, repeatedly resets a count value and restarts a count operation for every bit number, resets a count value together with the rising or falling of the half-cycle signal, and outputs a pulse signal in which a rising or falling edge is inverted for every reset that occurs while the count operation is being performed; and a duty control signal generating component that generates a duty control signal to determine a duty ratio of a control signal to control driving of the single-phase brushless motor, based on at least two pulse signals selected from the pulse signals output from the plurality of counters.

According to the brushless motor driving apparatus of the disclosure, a rotation signal output circuit outputs a rotation signal becoming one cycle with respect to one rotation of a rotation body of a single-phase brushless motor, and a half-cycle signal generating circuit generates a half-cycle signal where rising and falling edges arc inverted for every half cycle of the rotation body, based on the rotation signal output from the rotation signal output circuit, and outputs the half-cycle signal.

In the brushless motor driving apparatus of the disclosure, plural counters are provided. Each of the plural counters counts a different bit number, repeats reset of a count value and restart of a count operation for every bit number, and has the count value that is reset with the rising and falling edges of the half-cycle signal. Each of the plural counters outputs a pulse signal where the rising and falling edges are inverted for every reset, while the count operation is performed. As such, each of the plural counters that have the different bit numbers repeats the reset of the count value and the restart of the count operation for every bit number, and outputs the pulse signal where the rising and falling edges are inverted for every reset. Therefore, even though the count operation is performed based on a clock signal having the same frequency, the pulse signals having the various pulse widths are output.

A duty control signal generating circuit generates a duty control signal to determine a duty ratio of a control signal to control driving of the single-phase brushless motor, based on at least two pulse signals selected from the pulse signals output from plural counters.

As such, since the duty control signal is generated based on at least two pulse signals selected from the pulse signals output from the plural counters having the different bit numbers, duty control to restrict the rotation speed of the motor can be performed without requiring the complicated circuit.

According to the brushless motor driving apparatus of the disclosure, the plural counters can have bit numbers different from each other by one bit, respectively. The timing when the count value is reset becomes ½, whenever the bit number is different by one bit, and the pulse width of the pulse signal becomes ½. Therefore, the pulse signals selected to generate the duty control signal can be easily selected.

According to the brushless motor driving apparatus of the disclosure, the duty control signal generating circuit can perform an exclusive OR operation on the selected pulse signals to generate the duty control signal.

### BRIEF DESCRIPTION OF THE DRAWINGS

Exemplary embodiments of the present disclosure will be described in detail based on the following figures, wherein:

FIG. 1 is a diagram illustrating the schematic configuration of a brushless motor driving apparatus according to an exemplary embodiment of the present disclosure;

FIG. 2 is a diagram illustrating the schematic configuration of an H bridge circuit that becomes a basic circuit of a switching element to apply a voltage to a coil and determine a current direction;

FIG. 3 is a diagram illustrating the schematic configuration of a control circuit in the brushless motor driving apparatus according to the exemplary embodiment;

FIG. 4 is a timing chart when the brushless motor driving apparatus is operated; and

FIG. 5 is a timing chart related to duty control of the brushless motor driving apparatus.

### DETAILED DESCRIPTION

The exemplary embodiments of the present disclosure are described and illustrated below to encompass brushless motor driving apparatus and, more particularly, to a brushless motor driving apparatus that can control a duty ratio of a control signal to control driving of a brushless motor to restrict a rotation speed. Of course, it will be apparent to those of ordinary skill in the art that the preferred embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure. Hereinafter, an exemplary embodiment of the present disclosure will be described in detail with reference to the drawings.

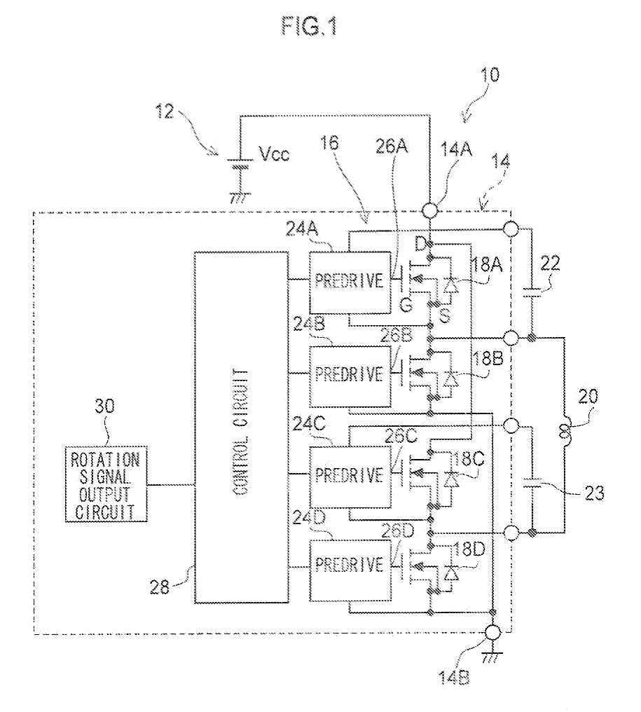

FIG. 1 illustrates the schematic configuration of a brushless motor driving apparatus 10 according to this exemplary embodiment.

The brushless motor driving apparatus 10 includes a power supply unit 12 that has electromotive force of a voltage Vcc. A negative terminal of the power supply unit 12 is connected to a ground and a positive terminal thereof is connected to a brushless motor driving voltage input terminal 14A of an integrated circuit 14. The integrated circuit 14 is provided with a ground terminal 14B, and the ground terminal 14B forms a pair with the brushless motor driving voltage input terminal 14A.

Between the brushless motor driving voltage input terminal 14A and the ground terminal 14B of the integrated circuit 14, an H bridge circuit 16 that constitutes a portion of a driving voltage generating circuit is formed.

The H bridge circuit 16 has four NMOS transistors 18A, 18B, 18C, and 18D provided in the totem pole configuration. By the totem pole configuration, the four NMOS transistors 18A, 18B, 18C, and 18D as one set are overlapped with plural stages according to necessity, and a power stage can be set.

In the H bridge circuit 16, the brushless motor driving voltage input terminal 14A is connected to drains of the NMOS transistors 18A and 18C and sources of the NMOS transistors 18B and 18D are connected to the ground terminal 14B. A source of the NMOS transistor 18A is connected to a drain of the NMOS transistor 18B and a source of the NMOS transistor 18C is connected to a drain of the NMOS transistor 18D. A coil 20 of a brushless motor is connected between the source of the NMOS transistor 18A and the drain of the NMOS transistor 18B and between the source of the NMOS transistor 18C and the drain of the NMOS transistor 18D.

A capacitor 22 is connected with one end of the coil 20 and a capacitor 23 is connected with the other end of the coil 20.

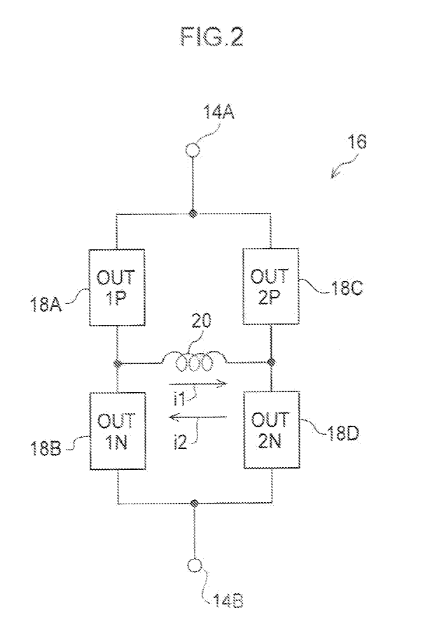

FIG. 2 is a circuit diagram of when the NMOS transistors 18A, 18B, 18C, and 18D arc simplified as switching elements OUT1P, OUT1N, OUT2P, and OUT2N and arc assembled in an H type. In FIG. 2, if the NMOS transistors 18A and 18D, that is, the switching elements OUT1P and OUT2N arc turned on, a current i1 flows through the coil 20 from the left side to the right side of FIG. 2. Meanwhile, if the NMOS transistors 18C and 18B, that is, the switching elements OUT2P and OUT1N are turned on, a current i2 flows through the coil 20 from the right side to the left side of FIG. 2.

As illustrated in FIG. 1, in the H bridge circuit 16 that has the above-described configuration, gates of the NMOS transistors 18A, 18B, 18C, and 18D arc connected to output terminals 26A, 26B, 26C, and 26D of predrives 24A, 24B, 24C, and 24D, and the drains and the sources of the NMOS transistors 18A, 18B, 18C, and 18D are electrically connected by signals output from the predrives 24A, 24B, 24C, and 24D.

The predrives 24A, 2413, 24C, and 24D control ON/OFF of the NMOS transistors 18A, 18B, 18C, and 18D according to signals output from a control circuit 28.

The control circuit 28 is connected to a rotation signal output circuit 30 that outputs a rotation signal becoming one cycle with respect to one rotation of a rotor of the brushless motor, generates an FG signal from the rotation signal that is output from the rotation signal output circuit 30, and generates ON/OFF signals that are transmitted to the predrives 24A, 24B, 24C, and 24D.

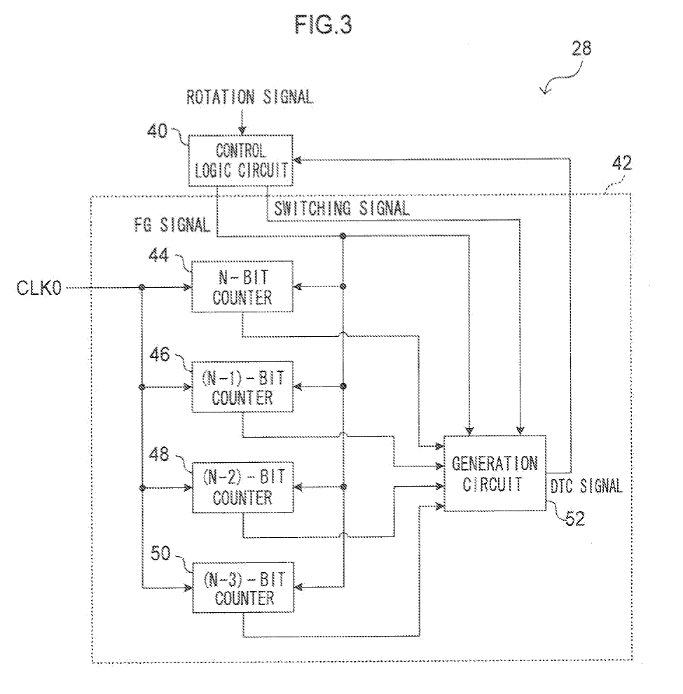

FIG. 3 illustrates the schematic configuration of the control circuit 28. The control circuit 28 includes a control logic circuit 40 and a duty control circuit 42.

The control logic circuit 40 generates a rectangular-wave FG signal that is inverted by a zero cross signal of the rotation signal and indicates a half cycle of the rotation of the rotor, based on the rotation signal, and outputs the rectangular-wave FG signal to the duty control circuit 42. In order to obtain a desired duty ratio, the control logic circuit 40 outputs a switching signal to select a pulse signal from each counter to be described in detail below to the duty control circuit 42.

The duty control circuit 42 includes an N-bit counter 44, a (N-1)-bit counter 46, a (N-2)-bit counter 48, and a (N-3)-bit counter 50 that count a half cycle of the rotation of the rotor in synchronization with the same clock signal CLK0, based on the FG signal. Each counter performs a count operation during a period during which the FG signal is input, resets a count value whenever a count operation corresponding to each bit number is performed, and restarts the count operation. Even at timing when rising and falling edges of the FG signal are inverted, each counter resets the count value and restarts the count operation. During the count operation, each counter outputs a pulse signal where the rising and falling edges are inverted, whenever the reset is made. At the timing when the rising and falling edges of the FG signal are inverted, each counter makes the pulse signal fall.

The duty control circuit 42 includes a generation circuit 52 that receives pulse signals from the (N-1)-bit counter 46, the (N-2)-bit counter 48, and the (N-3)-bit counter 50. The generation circuit 52 selects the pulse signals output from the (N-1)-bit counter 46 and the (N-2)-bit counter 48 or the pulse signals output from the (N-1)-bit counter 46, the (N-2)-bit counter 48 and the (N-3)-bit counter 50, based on a switching signal received from the control logic circuit 40, performs an exclusive OR operation on the selected pulse signals to generate a duty control signal DTC, and outputs the generated duty control signal DTC to the control logic circuit 40.

Next, the function according to this exemplary embodiment will be described.

First, the operation of the brushless motor driving apparatus 10 according to this exemplary embodiment will be described.

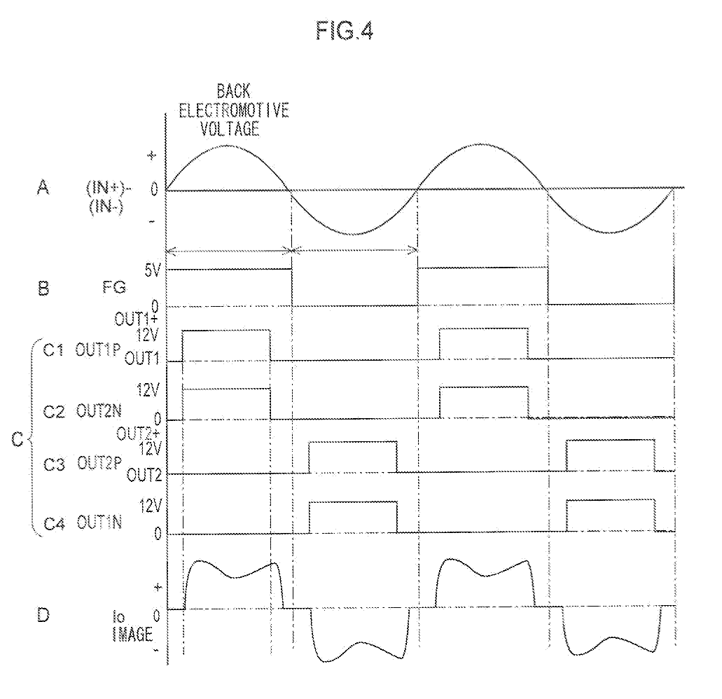

A graph A of an uppermost stage illustrated in FIG. 4 illustrates a waveform of an output signal where a back electromotive voltage when the brushless motor is driven (when the brushless motor runs) is detected. The output signal corresponds to a rotation signal.

A graph B of a two stage from the upper side of FIG. 4 illustrates a waveform of an FG signal that is generated based on the graph A, and the FG signal becomes a signal that is inverted with a zero cross signal of the output signal (graph A) of the back electromotive voltage.

Graphs C1, C2, C3, and C4 of third to sixth stages from the upper side of FIG. 4 illustrate waveforms of signals that are input to the gates of the NMOS transistors 18A, 18B, 18C, and 18D of the H bridge circuit 16 (signals that cause the drains and the sources to be electrically connected), and these signals arc driving signals of the NMOS transistors 18A, 188, 18C, and 18D.

A symbol P indicates a drive state at the high side illustrated in FIG. 2 and a symbol N indicates a drive state at the low side illustrated in FIG. 2. A figure “1” indicates the left side of a half bridge of the H bridge circuit 16 illustrated in FIG. 2 and a figure “2” indicates the right side of the half bridge. If the NMOS transistors 18A, 18B, 18C, and 18D are represented by these symbols and figures, they are represented as follows (correspondence of FIGS. 1 and 2).

(1) NMOS transistor 18A→OUT1P

(2) NMOS transistor 18B→OUT1N

(3) NMOS transistor 18C→OUT2P

(4) NMOS transistor 18D→OUT2N

As illustrated in FIG. 4, during a first period, the OUT1P and OUT2N are turned on and supplied with power, and the OUT2P and OUT1N are turned on and supplied with power. As illustrated by a graph D of a lowermost stage of FIG. 4, reverse currents (i1→i2→i1→i2→. . . ) alternately flow through the coil 20. As a result, the brushless motor is rotated. As illustrated by the graph D, in the vicinity of the zero cross of the back electromotive voltage, a current does not flow for a predetermined time, by the duty control to be described below.

Next, the operation of the duty control in the brushless motor driving apparatus 10 according to this exemplary embodiment will be described.

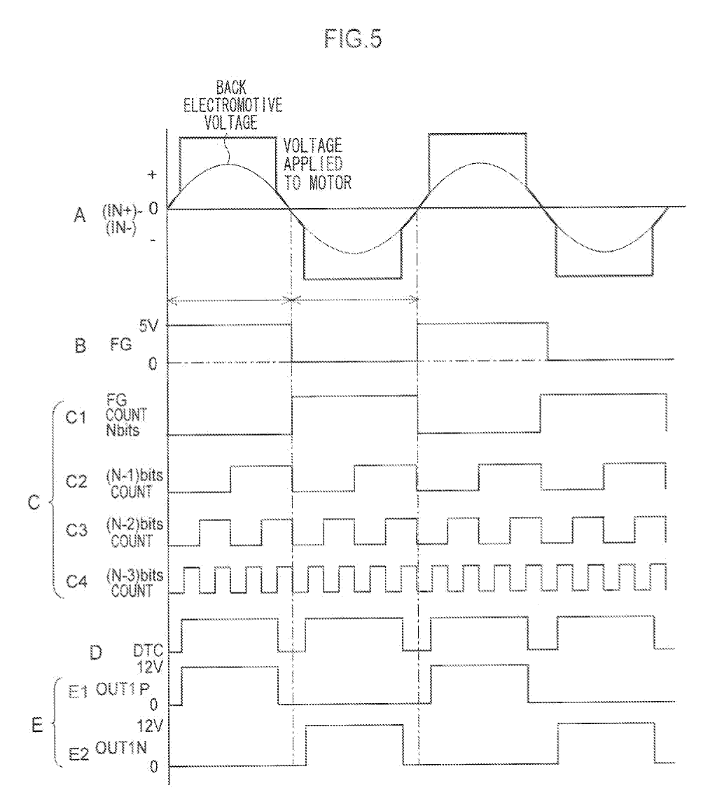

As illustrated in FIG. 5, a graph A of an uppermost stage illustrates a waveform of an output signal where a back electromotive voltage when the brushless motor is driven (when the brushless motor runs) and a voltage applied between motor terminals are detected. The output signal corresponds to the rotation signal.

A graph B of a second stage from the upper side of FIG. 5 illustrates a waveform of an FG signal that is generated based on the graph A, and the FG signal becomes a signal that is inverted with a zero cross signal of the output signal (graph A) of the back electromotive voltage and the voltage applied between the motor terminals.

Graphs C1, C2, C3, and C4 of third to sixth stages from the upper side of FIG. 5 illustrate waveforms of pulse signals that arc output from the individual counters. The graphs C1, C2, C3, and C4 correspond to outputs of the N-bit counter 44, the (N-1)-bit counter 46, the (N-2)-bit counter 48, and the (N-3)-bit counter 50, respectively.

A graph D of a seventh stage from the upper side of FIG. 5 illustrates a waveform of a duty control signal DTC that is generated based on the graphs C2, C3 and C4.

A graph E1 of an eighth stage from the upper side of FIG. 5 illustrates a waveform of a drive signal at the high side of a half bridge 1 of the H bridge circuit 16, and a graph E2 illustrates a waveform of a drive signal at the low side.

The rotation signal output circuit 30 detects the back electromotive voltage and the voltage (refer to graph A of PIG. 5) applied between the motor terminals. The control logic circuit 40 generates a rectangular-wave PG signal that becomes an ON state in a positive half cycle, is inverted to correspond to the approximately zero cross signal of the output signal, and becomes an OFF state in a negative half cycle, based on the output signal of the back electromotive voltage and the voltage applied between the motor terminals. The FG signal is output to the N-bit counter 44, the (N-1)-bit counter 46, the (N-2)-bit counter 48, the (N-3)-bit counter 50, and the generation circuit 52.

Meanwhile, a switching signal to obtain a desired duty ratio is input from the control logic circuit 40 to the generation circuit 52. In this case, it is assumed that a switching signal to obtain a duty ratio of 75% is input.

Each counter receives a clock signal CLK0 having the same frequency, performs a count operation during a period where the PG signal is input in synchronization with the clock signal CLK0, and outputs a pulse signal during a period where the count operation is performed. Since the count corresponding to the (N-1)-bit number ends at a point of time when ½ of the count number counted by the N-bit counter 44 is counted, the (N-1)-bit counter 46 resets the count value, inverts the pulse signal, and restarts the count operation. Since the count corresponding to the (N-2)-bit number ends at a point of time when ¼ of the count number counted by the N-bit counter 44 is counted, the (N-2)-bit counter 48 resets the count value, inverts the pulse signal, and restarts the count operation. Similar to the above case, at a point of time when ½ or ¾ of the count number counted by the N-bit counter 44 is counted, the corresponding counter resets the count value, inverts the pulse signal, and restarts the count operation.

Since the count corresponding to the (N-3)-bit number ends at a point of time when ⅛ of the count number counted by the N-bit counter 44 is counted, the (N-3)-bit counter 50 resets the count value, inverts the pulse signal, and restarts the count operation. Similar to the above case, at a point of time when ¼, ⅜, ½, 5/8, 3/4, or 7/8 of the count number counted by the N-bit counter 44 is counted, the corresponding counter resets the count value, inverts the pulse signal, and restarts the count operation.

At timing when the FG signal is inverted, all of the counters reset the count values and cause the pulse signals to fall.

The pulse signal that is output from each counter is input to the generation circuit 52. Based on the switching signal to obtain the duty ratio of 75%, the generation circuit 52 selects the pulse signals output from the (N-1)-bit counter 46, (N-2)-bit counter 48 and the (N-3)-bit counter 50, performs an exclusive OR operation on the selected two pulse signals to generate the duty control signal DTC illustrated by the graph D of FIG. 5, and outputs the duty control signal DTC to the control logic circuit 40.

The control logic circuit 40 generates the driving signals of the OUT1P and OUT1N illustrated by the graphs E1 and E2 of FIG. 5, based on the ON/OFF control logic of the OUT1P and OUT1N and the duty control signal DTC, and outputs the driving signals to the individual predrives.

As described above, according to the brushless motor driving apparatus in this exemplary embodiment, the duty control signals arc generated using the pulse signals output from the plural counters where the bit numbers are different, and the clock signal that is input to each counter can be made to have the same frequency. Therefore, the duty control to restrict the rotation speed of the motor can be performed without requiring the complicated circuit. The bit number of the counter is decreased one by one whenever the stages of the counters are overlapped. As a result, the bit number of the counter circuit can be greatly reduced and the same effect as that of the related art is obtained by the small circuit.

In this exemplary embodiment, the single-phase full-wave brushless motor driving apparatus has been described. However, an H bridge drive output control circuit of a bidirectional power supply type for single-phase drive is replaced by a driver output control circuit of a unidirectional power supply type, the disclosure can be applied to a two-phase half-wave brushless motor driving apparatus.

In this exemplary embodiment, the detection signal of the back electromotive voltage is used as the rotation signal. However, a rotation signal that is detected by a hall clement may be used.

Following from the above description and embodiment, it should be apparent to those of ordinary skill in the art that, while the foregoing constitutes an exemplary embodiment of the present disclosure, the disclosure is not necessarily limited to this precise embodiment and that changes may be made to this embodiment without departing from the scope of the invention as defined by the claims. Additionally, it is to be understood that the invention is defined by the claims and it is not intended that any limitations or elements describing the exemplary embodiment set forth herein are to be incorporated into the interpretation of any claim element unless such limitation or clement is explicitly stated. Likewise, it is to be understood that it is not necessary to meet any or all of the identified advantages or objects of the disclosure discussed herein in order to fall within the scope of any claims, since the invention is defined by the claims and since inherent and/or unforeseen advantages of the present disclosure may exist even though they may not have been explicitly discussed herein.

What is claimed is:

1. A brushless motor driving apparatus comprising:
a rotation signal output component that outputs a rotation signal that represents one cycle corresponding to one rotation of a rotation body of a single-phase brushless motor;
a half-cycle signal generating component that generates a half-cycle signal in which a rising or falling edge is inverted every half cycle of the rotation body, based on the rotation signal output from the rotation signal output component, and outputs the half-cycle signal;
a plurality of counters, each of which uses a different bit number to count, repeatedly resets a count value and restarts a count operation for every bit number, resets a count value together with the rising or falling of the half-cycle signal, and outputs a pulse signal in which a rising or falling edge is inverted for every reset that occurs while the count operation is being performed; and
a duty control signal generating component that generates a duty control signal to determine a duty ratio of a control signal to control driving of the single-phase brushless motor, based on at least two pulse signals selected from the pulse signals output from the plurality of counters.

2. The brushless motor driving apparatus of claim 1, wherein the plurality of counters have bit numbers different from each other by one bit, respectively.

3. The brushless motor driving apparatus of claim 1, wherein the duty control signal generating component performs an exclusive OR operation on the selected pulse signals to generate the duty control signal.
